(19) United States
(12) Patent Application Publication
(10) Pub. No.: US 2025/0039180 A1
(43) Pub. Date: Jan. 30, 2025

(54) MOBILITY SERVICE PROVISION SYSTEM, IN-VEHICLE SYSTEM, MANAGEMENT SERVER, ACCESS CONTROL METHOD, AND ACCESS CONTROL PROGRAM

(71) Applicant: Denso Corporation, Kariya-city (JP)

(72) Inventors: Hideyuki HONYA, Kariya-city (JP); Hideyuki Yamaguchi, Kariya-city (JP); Satoshi Niwa, Kariya-city (JP)

(21) Appl. No.: 18/917,820

(22) Filed: Oct. 16, 2024

Related U.S. Application Data
(63) Continuation of application No. PCT/JP2023/014217, filed on Apr. 6, 2023.

(30) Foreign Application Priority Data
Apr. 28, 2022 (JP) 2022-074970

(51) Int. Cl. H04L 9/40

(52) U.S. Cl. CPC H04L 63/10

(57) ABSTRACT

According to a mobility service provision system, an in-vehicle system, a management server, an access control method, a non-transitory computer-readable storage medium storing a program, each function block is mounted in one of a plurality of electronic control units and configured to execute a predetermined process, an authorization policy that defines an access privilege between the plurality of function blocks is stored, and a static viewpoint policy is generated by integrating a plurality of viewpoint-specific policies based on the plurality of viewpoint-specific policies that define the access privilege for each of a plurality of viewpoints focusing on a static attribute of the plurality of function blocks.

### CROSS REFERENCE TO RELATED APPLICATIONS

The present application is a continuation application of International Patent Application No. PCT/JP2023/014217 filed on Apr. 6, 2023, which designated the U.S. and claims the benefit of priority from Japanese Patent Application No. 2022-074970 filed on Apr. 28, 2022. The entire disclosures of all of the above applications are incorporated herein by reference.

### TECHNICAL FIELD

The present disclosure relates to a technology for controlling access.

### BACKGROUND

In a technology of a comparative example, in an open platform for mobile terminals, an access authorization policy is used to restrict access when access to resources or information held by the system via a service application is detected. The access authorization policy specifies who is permitted or prohibited to do what to what.

### SUMMARY

According to a mobility service provision system, an in-vehicle system, a management server, an access control method, a non-transitory computer-readable storage medium storing a program, each function block is mounted in one of a plurality of electronic control units and configured to execute a predetermined process, an authorization policy that defines an access privilege between the plurality of function blocks is stored, and a static viewpoint policy is generated by integrating a plurality of viewpoint-specific policies based on the plurality of viewpoint-specific policies that define the access privilege for each of a plurality of viewpoints focusing on a static attribute of the plurality of function blocks.

### BRIEF DESCRIPTION OF THE DRAWINGS

FIG. 1 is a block diagram showing a configuration of a mobility service provision system.

FIG. 2 is a block diagram showing a configuration of an ECU.

FIG. 3 is a block diagram showing a configuration of an API gateway.

FIG. 4 is an explanatory diagram showing contents of user information.

FIG. 5 is an explanatory diagram showing an outline of an authorization policy.

FIG. 6 is an explanatory diagram of API access privileges related to security levels.

FIG. 7 is an explanatory diagram illustrating a static viewpoint-specific policy with security as a viewpoint.

FIG. 8 is an explanatory diagram illustrating a static viewpoint-specific policy with a corporate property as a viewpoint.

FIG. 9 is an explanatory diagram illustrating a dynamic viewpoint-specific policy with a personal property as a viewpoint, a dynamic viewpoint policy with a privacy as a viewpoint, and a dynamic policy that integrates the dynamic viewpoint-specific policies.

FIG. 10 is an explanatory diagram illustrating a static policy that integrates static viewpoint-specific policies.

FIG. 11 is a flowchart of an access restriction process executed by an access controller.

FIG. 12 is a block diagram showing a configuration of a cloud server.

FIG. 13 is a flowchart of a policy generation provision process executed by the cloud server.

### DETAILED DESCRIPTION

It is expected that in the future, an unspecified number of third-party service applications will be installed in electronic control systems installed in vehicles (hereinafter referred to as “in-vehicle systems”). When third-party service applications or the like access the vehicle's functions and information, the access must be restricted as necessary. In addition, as the in-vehicle systems become more sophisticated and a wider variety of service applications are installed, access control becomes more complex. It is necessary to control access while ensuring real-time performance and utilizing the limited resources of the in-vehicle system.

One example of the present disclosure provides a technology for simplifying access control using an access authorization policy.

A mobility service provision system according to one example embodiment of the present disclosure includes an in-vehicle system and an authorization policy provision unit. The in-vehicle system includes a plurality of electronic control units mounted on a vehicle and connected to an in-vehicle network. The authorization policy provision unit is placed outside the vehicle.

The in-vehicle system includes a plurality of function blocks and a coordination controller. Each of the plurality of function blocks is mounted on one of the plurality of electronic control units, and is configured to execute a predetermined process. The coordination controller is configured to implement coordination between a plurality of function blocks.

The coordination controller includes a policy storage and an access controller. The policy storage acquires and stores an authorization policy that defines an access privilege between the plurality of function blocks from the authorization policy provision unit. The access controller receives an access request from a use source block, which is one of the plurality of function blocks, to a use destination block, which is another of the plurality of function blocks. When the access request is received, the access controller uses the authorization policy stored in the policy storage to determine whether the use source block has access privilege to the use destination block. When it is determined that the access privilege is present, the access controller transmits the access request to the use destination block.

The authorization policy provision unit provides a static viewpoint policy generated by integrating a plurality of viewpoint-specific policies to the in-vehicle system as an authorization policy. In the multiple viewpoint-specific policies, the access privilege is defined for each of multiple viewpoints focusing on a static attribute of the function blocks.

According to this configuration, the in-vehicle system determines the presence or absence of the access privilege from the use source block to the use destination block, using an authorization policy that includes a static viewpoint policy that integrates a plurality of viewpoint-specific policies. Accordingly, the in-vehicle system can easily determine the presence or absence of access privilege all at once, without making a determination for each of a plurality of viewpoint-specific policies individually. Moreover, the authorization policy is acquired from outside the vehicle. As a result, it is possible to reduce the load required for determining the access privilege in the in-vehicle system.

An in-vehicle system according to another example embodiment of the present disclosure includes a plurality of function blocks and a coordination controller. Each of the plurality of function blocks is mounted on one of the plurality of electronic control units connected to an in-vehicle network, and is configured to execute a predetermined process. The coordination controller implements coordination between a plurality of function blocks.

The coordination controller includes a policy storage and an access controller. The policy storage stores an authorization policy that specifies access privileges between the function blocks. The access controller receives an access request from a use source block, which is one of the plurality of function blocks, to a use destination block, which is another of the plurality of function blocks. When the access request is received, the access controller uses the authorization policy stored in the policy storage to determine whether the use source block has access privilege to the use destination block. When it is determined that the access privilege is present, the access controller transmits the access request to the use destination block.

The authorization policy includes a static viewpoint policy generated by integrating a plurality of viewpoint-specific policies based on the plurality of viewpoint-specific policies that define the access privilege for each of a plurality of viewpoints focusing on a static attribute of the plurality of function blocks.

A management server communicably connected to a vehicle including an in-vehicle system including a plurality of electronic control units connected to an in-vehicle network. The management server includes an authorization policy storage, an authorization policy generation unit, and an authorization policy provision unit.

The authorization policy storage is mounted in any one of a plurality of electronic control units and stores an authorization policy referenced for control of an access privilege to a use destination block from a use source block. The use source block is one of the function blocks, each configured to execute a predetermined process. The use destination block is another of the function blocks.

The authorization policy generation unit generates a static viewpoint policy by integrating a plurality of static viewpoint-specific policies based on the plurality of static viewpoint-specific policies that define the access privilege for each of a plurality of viewpoints focusing on a static attribute of the plurality of function blocks. Moreover, the authorization policy generation unit stores the generated static viewpoint policy in the authorization policy storage as the authorization policy.

The authorization policy provision unit provides the authorization policy stored in the authorization policy storage to the vehicle.

According to another example embodiment of the present disclosure, in an access control method, at least one of a plurality of electronic control units connected to an in-vehicle network controls access between a plurality of function blocks using an authorization policy that defines an access privilege between the function blocks. Each of the plurality of function blocks is mounted on one of the plurality of electronic control units, and executes a predetermined process.

The access control method includes: using, as the authorization policy, a static viewpoint policy generated by integrating a plurality of viewpoint-specific policies based on the plurality of viewpoint-specific policies that define the access privilege for each of a plurality of viewpoints focusing on a static attribute of the plurality of function blocks; when receiving an access request from a use source block that is one of the plurality of function blocks to a use destination block that is another of the plurality of function blocks, determining whether the access privilege of the use source block to the use destination block is present according to the authorization policy; and transmitting the access request to the use destination block when determined that the access privilege is present.

According to another example embodiment of the present disclosure, a program controls an access between a plurality of function blocks by using an authorization policy that defines an access privilege between the plurality of function blocks, each which is mounted on any one of a plurality of electronic control units and configured to execute a predetermined process, the at least one of a plurality of electronic control units being connected to an in-vehicle network.

The access control program is configured to: use, as the authorization policy, a static viewpoint policy generated by integrating a plurality of viewpoint-specific policies based on the plurality of viewpoint-specific policies that define the access privilege for each of a plurality of viewpoints focusing on a static attribute of the plurality of function blocks; and cause a computer to implement a function of: when receiving an access request from a use source block that is one of the plurality of function blocks to a use destination block that is another of the plurality of function blocks, determining whether the access privilege of the use source block to the use destination block is present according to the authorization policy; and transmitting the access request to the use destination block when determined that the access privilege is present.

Hereinafter, an embodiment of the present disclosure will be described with reference to drawings.

### 1. Configuration

A mobility service provision system 1 of the present embodiment includes an in-vehicle system 100 mounted in a vehicle, and a cloud server 200. The vehicle may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the traveling source. Hereinafter, the vehicle equipped with the in-vehicle system 100 will be simply referred to as a vehicle.

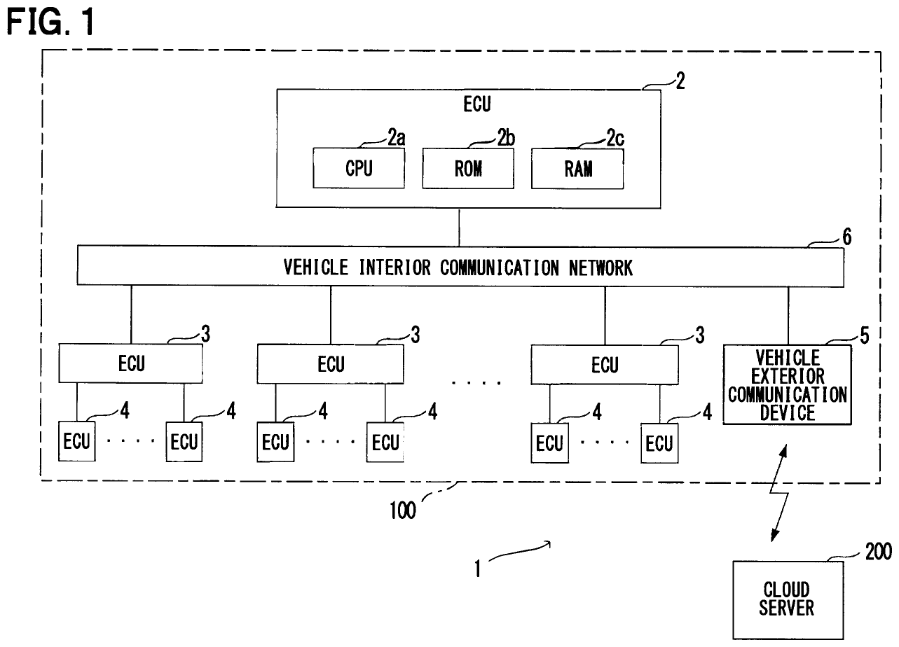

As shown in FIG. 1, the in-vehicle system 100 includes one ECU 2, multiple ECUs 3, multiple ECUs 4, a vehicle exterior communication device 5, and a vehicle interior communication network 6. The ECU is an abbreviation for Electronic Control Unit.

The ECU 2 controls the plurality of ECUs 3 to achieve coordinated control of the entire vehicle.

The ECU 3 is provided for each domain divided by function in the vehicle, and mainly controls a plurality of ECUs 4 existing within that domain. Each ECU 3 is connected to the ECU 4 under the control thereof via an individually provided lower layer network (for example, CAN). The CAN is a registered trademark and is an abbreviation for Controller Area Network. The ECU 3 has a function of centrally managing access privilege of the ECU 4 under the control thereof and authenticating users. The domain includes, for example, a powertrain, a body, a chassis, a cockpit, and the like.

The ECUs 4 connected to the ECU 3 belonging to the powertrain domain include, for example, an ECU 4 that controls the engine, an ECU 4 that controls the motor, and an ECU 4 that controls the battery.

The ECUs 4 connected to the ECU 3 belonging to the body domain include, for example, an ECU 4 that controls the air conditioner and an ECU 4 that controls the doors.

The ECUs 4 connected to the ECU 3 belonging to the chassis domain include, for example, an ECU that controls the brakes and an ECU that controls the steering.

The ECUs 4 connected to the ECU 3 belonging to the cockpit domain include, for example, an ECU 4 that controls the display of meters and navigation, and an ECU 4 that controls input devices operated by vehicle occupants.

The vehicle exterior communication device 5 performs data communication with vehicle exterior devices such as the cloud server 200 via a wide area wireless communication network.

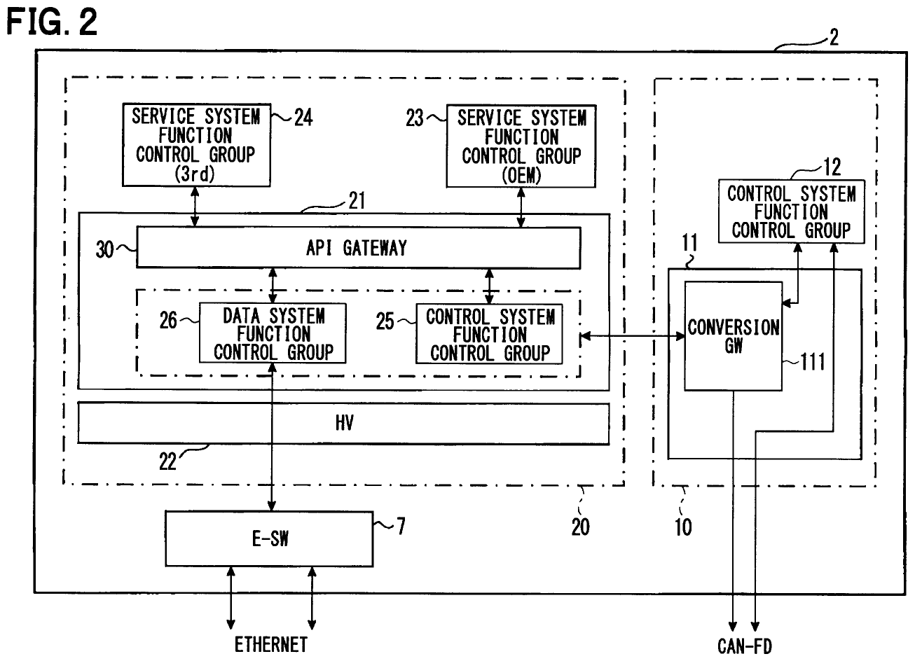

The vehicle interior communication network 6 includes CAN FD and Ethernet. The Ethernet is a registered trademark. The CAN FD is an abbreviation for CAN with Flexible Data Rate. The CAN FD connects ECU 2 to each ECU 3 and the vehicle exterior communication device 5 via a bus. The Ethernet connects ECU 2 and each ECU 3 and the vehicle exterior communication device 5 individually. The ECU 2 is provided with an Ethernet switch 7 for switching the Ethernet to be used, as shown in FIG. 2.

The ECU 2 is an electronic control unit mainly including a microcomputer including a CPU 2a, a ROM 2b, a RAM 2c, and the like. Various functions of the microcomputer are implemented by the CPU 2a executing programs stored in a non-transitory tangible storage medium. In this example, the ROM 2b corresponds to a non-transitory tangible storage medium that stores a program. Further, by executing this program, a method corresponding to the program is executed. Note that partial or all of the functions executed by the CPU 2a may be implemented by a hardware circuit, such as one or more ICs. Further, the number of the microcomputers constituting the ECU 2 may be one or more.

The ECU 3, the ECU 4, and the vehicle exterior communication device 5 are all electronic control units mainly including a microcomputer provided with a CPU, ROM, RAM, and the like, similarly to the ECU 2. Further, the number of the microcomputers constituting the ECU 3 and ECU 4, and the vehicle exterior communication device 5 may be one or more.

Hereinafter, unless otherwise specified, the ECU 2, ECU 3, ECU 4, and the vehicle exterior communication device 5 will be collectively referred to as in-vehicle devices 2 to 5.

The ECU 2 has a real-time processing unit 10 and an application processing unit 20. When the ECU 2 includes multiple CPUs 2a, the real-time processing unit 10 and the application processing unit 20 may be implemented by processes executed by the same CPU or by processes executed by different CPUs.

The real-time processing unit 10 cooperates with the in-vehicle devices 3 to 5 connected via the CAN FD to execute vehicle control and the like that requires real-time performance. The application processing unit 20 cooperates with the in-vehicle devices 3 to 5 connected via Ethernet to execute various applications (for example, entertainment applications) that require high processing performance.

The application processing unit 20 has a function to transmit instructions based on the processes of various applications to the real-time processing unit 10. The real-time processing unit 10 has a function to transmit information, and the like collected from the in-vehicle devices 3 to 5, to the application processing unit 20 via the CAN FD. The real-time processing unit 10 and the application processing unit 20 cooperate with each other to implement various functions.

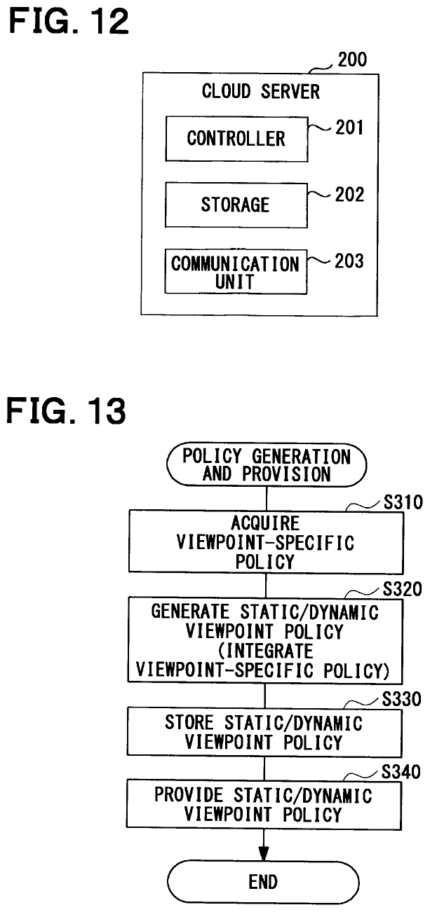

As shown in FIG. 12, the cloud server 200 includes a controller 201, a storage 202, and a communication unit 203.

The controller 201 is an electronic control unit mainly including a microcomputer including a CPU 201a, a ROM 201b, a RAM 201c, and the like. Various functions of the microcomputer are implemented by the CPU 201a executing programs stored in a non-transitory tangible storage medium. In this example, the ROM 201b corresponds to a non-transitory tangible storage medium that stores a program. Further, by executing this program, a method corresponding to the program is executed. The controller 201 executes at least a policy generation and provision process.

The storage 202 stores multiple authorization policies. The authorization policies stored in the storage 202 include a static viewpoint policy and a dynamic viewpoint policy generated by the policy generation provision process executed by the controller 201. The authorization policy may also include multiple viewpoint-specific policies that are used when generating the static viewpoint policy and the dynamic viewpoint policy.

The communication unit 203 performs data communication with the in-vehicle system 100 installed in each of the multiple vehicles via a wide area wireless communication network.

### 2. Functional Configuration

The software installed in the in-vehicle devices 2 to 5 belonging to the in-vehicle system 100 is constructed in accordance with AUTOSAR. The AUTOSAR is an abbreviation for Automotive Open System Architecture. The AUTOSAR provides not only communication between software components (hereinafter referred to as SW-C) provided to implement various applications, but also functions related to connection to the cloud, security, and the like. The SW-C is parted software to implement a certain function. The application program includes one or more SW-C. Note that the software of the mobility service provision system 1 does not necessarily need to be built along AUTOSAR.

Each of the in-vehicle devices 2 to 5 includes a platform. The platform provides an environment for running SW-C written in a hardware-independent format.

The platform includes a runtime environment (hereinafter, RTE) and underlying software (hereinafter, BSW). The RTE is the interface between SW-C and between SW-C and BSW. The BSW is the hierarchy connecting hardware and SW-C, including OS, driver, middleware, etc. The functions of the BSW are divided into small modules and the functions of each module are provided to the SW-C via API. The API is an abbreviation for Application Programming Interface.

Hereinafter, the platform provided in the real-time processing unit 10 is referred to as a first platform (hereinafter, first PF) 11, and the platform provided in the application processing unit 20 is referred to as a second platform (hereinafter, second PF) 21.

As shown in FIG. 2, the real-time processing unit 10 includes a control system function block group 12 as a collection of service applications (hereinafter referred to as service applications) operating on the first PF 11. The service application is an application that receives requests from clients, processes them, and returns results. Each service application includes one or more SW-Cs.

The control system function block group 12 is an application for providing an API for accepting instructions related to the movement of the vehicle and for controlling the instructions accepted by the API to implement consistent vehicle control. The control system function block group 12 outputs various instructions via the CAN FD to the in-vehicle devices 3 to 5 in which there is an embodiment that executes control based on the directive.

The first PF 11 is provided with a conversion gateway 111. The conversion gateway 111 has a function to convert the communication frame received by the real-time processing unit 10 via the CAN FD into Ethernet format and provide it to the application processing unit 20. In addition, the conversion gateway 111 has a function to convert the communication frame in the Ethernet format provided by the application processing unit 20 to the CAN format.

The application processing unit 20 includes a hypervisor 22, and executes software on a plurality of virtual machines. Note that the hypervisor 22 may be omitted.

The application processing unit 20 includes service system function block groups 23, 24 as a collection of service applications operating on the second PF 21.

The service system function block group 23 is a collection of service applications (hereinafter, OEM applications) provided by an OEM. Each OEM application has one or more SW-Cs. The OEM is the vehicle manufacturer that produced the vehicle. The OEM is an abbreviation for original equipment manufacturer. Further, the OEM applications may include applications developed by the OEM itself and apps developed by other vendors.

The service system function block group 24 is a collection of service applications provided by third parties (hereinafter, referred to as 3rd applications). Each 3rd application has one or more SW-Cs. The third party is any party other than a vehicle owner and an OEM. The third party includes, for example, data utilization companies that provide services by collecting data from vehicles.

The second PF 21 includes a control system function block group 25, a data system function block group 26, and an API gateway 30.

The control system function block group 25 is a set of service applications equipped with an API for accepting requests related to vehicle control from the service system function block groups 23, 24. The control system function block group 25 converts the API access request that is expressed in a vehicle-independent format and from the service system function block groups 23, 24 into an API access request expressed in a vehicle-dependent format and provides it to the real-time processing unit 10. The API provided by the control system function block group 25 includes a motion system API for controlling motion of the vehicle and a non-motion system API other than the motion system API. The API access request accepted by the motion system API is transferred to the control system function block group 12, and is transferred from the control system function block group 12 to the in-vehicle devices 3 to 5 and the like which execute control based on the request via the vehicle interior communication network 6 such as the CAN FD. The API access request accepted by the non-motion system API is transferred to the in-vehicle devices 3 to 5 and the like which execute control based on the request via the vehicle interior communication network 6 such as the CAN FD.

The data system function block group 26 is a set of service applications equipped with an API for handling vehicle data acquired and stored via the real-time processing unit 10. The data system function block group 26 has a function of abstracting and storing vehicle data expressed in a vehicle-dependent format supplied from the real-time processing unit 10 into a vehicle-independent format. The data system function block group 26 may have an API that provides a function to transmit designated vehicle data to the in-vehicle device or the like via the vehicle interior communication network 6 such as the Ethernet. In particular, when the transmission destination is the vehicle exterior communication device 5, the vehicle exterior communication device 5 may upload the transmitted vehicle data to the cloud. In addition, the data system function block group 26 may have an API that provides a function for acquiring data from the cloud server 200.

It should be noted that communication with other in-vehicle devices 3 to 5 via the control system function block group 25 is not limited to CAN FD, but Ethernet or other communication means may be used. In addition, communication with other in-vehicle devices 3 to 5 via the data system function block group 26 may be performed not only by Ethernet, but also by CAN FD or other communication means.

In the following, the APIs provided by the service applications belonging to the control system function block group 25 and the data system function block group 26 are referred to as vehicle APIs.

The API gateway 30 is configured by utilizing the functions of the virtual function bus (hereinafter referred to as VFB). The VFB is middleware that enables communication between SW-C and between SW-C and BSW without awareness of hardware or communication protocol, also called software bus. The communication between SW-Cs is performed between service applications belonging to the service system function block groups 23 and 24, and refers to an access from a SW-C to an API provided by another SW-C. Communication between SW-C and BSW refers to access from SW-C to the vehicle API between service applications belonging to the service system function block groups 23, 24 and service applications belonging to the control system function block group 25 and the data system function block group 26. In the following description, it is assumed that the SW-C and the service application correspond one-to-one.

When a service application uses a function provided by the control system function block group 25 and the data system function block group 26, the service application transmits an API access request, which is an access request to the vehicle API. The API access request includes at least the process ID of the service application that is the source of use (hereinafter, use source application) and an API-ID that is information that uniquely identifies the vehicle API that is the destination of use (hereinafter, use destination API).

### 3. Access Restriction Mechanism

An access restriction mechanism will be described. In the access restriction mechanism, the API gateway 30 restricts access to the vehicle API from the service application. The access restriction mechanism is set in terms of S.F.O.P, which is an attribute defined as a security protection asset. The S is an abbreviation for Safety, and means access restrictions on API access that affect safety. The F is an abbreviation for Financial, and means access restrictions on API access that affects corporate or personal assets. The “O” is an abbreviation for “Operational” and means access restrictions on API access that affects the operational performance of the vehicle. The P is an abbreviation for Privacy, and means access restrictions on API access that affects privacy information.

The API gateway 30 is not provided only in the second PF 21 that operates on the application processing unit 20. The API gateway 30 is provided in the platforms of all in-vehicle devices 2 to 5 that may include any of the service system function block groups 23, 24, the control system function block group 25, and the data system function block group 26.

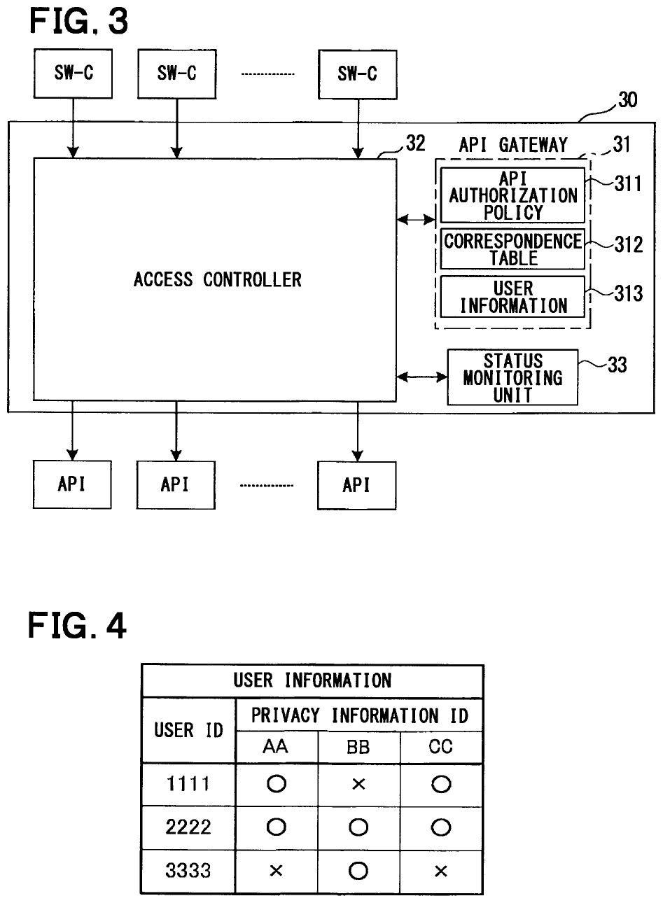

As shown in FIG. 3, the API gateway 30 includes an information storage 31, an access controller 32, and a status monitoring unit 33.

The information storage 31 stores an API authorization policy 311, a correspondence table 312, and user information 313. The correspondence table 312 is stored in the RAM 2c, and the API authorization policy 311 and the user information 313 are stored in the ROM 2b. However, the API authorization policy 311 and the user information 313 may be stored in the non-volatile RAM 2c.

The API authorization policy 311 is a collection of information for determining whether the service application has access privilege to the vehicle API. The API authorization policy 311 is downloaded from the cloud server 200 using, for example, a function of a service application belonging to the data system function block group 26, and stored in the information storage 31.

The correspondence table 312 includes information that correlates the process ID dynamically assigned to the process that is the execution unit of the program in the operating system (hereinafter referred to as the OS) with the unique application ID possessed by the service application executed in the process. In addition, the correspondence table 312 also includes information that associates a unique API-ID of each vehicle API with the process ID of a process assigned to a service application that is an entity that executes the function of the API. The correspondence table 312 is generated by the OS when a process for each service application is generated when the system starts.

The user information 313 is information that is referenced when, for example, determining whether the access privilege is granted using the API authorization policy 311, and is information that is arbitrarily set by the vehicle user. For example, as shown in FIG. 4, the user information 313 has contents that set, for each vehicle user identified by a user ID, whether to allow a request for access from a service application to privacy information identified by a privacy information ID. The user information 313 may include contact information for the vehicle user.

When the access controller 32 receives an API access request, the access controller 32 identifies the application ID of the use source application by using the correspondence table 312 from the process ID indicated in the API access request. The access controller 32 executes an access restriction process to determine whether or not access privilege exists, in accordance with the API authorization policy 311, based on the identified application ID and the API-ID of the use destination API indicated in the API access request. The access restriction process will be described in detail later.

The status monitoring unit 33 monitors the access status from each service application to each vehicle API, and generates status information indicating the access status. The status information is generated, for example, by tallying up the number of accesses to each vehicle API, the amount of data handled in processing, and the like for each use source application.

### 4. API Authorization Policy

A generation method of the API authorization policy 311 distributed by the cloud server 200 will be described.

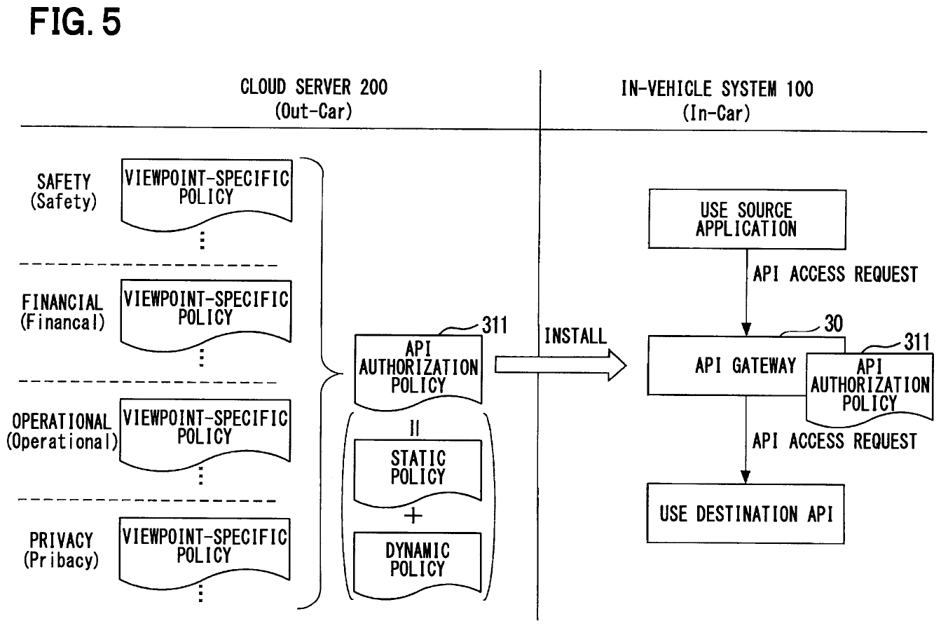

As shown in FIG. 5, the cloud server 200 prepares multiple viewpoint-specific policies generated from different viewpoints for each attribute of the S.F.O.P. The viewpoint-specific policies may be generated by the cloud server 200, or those generated outside the cloud server 200 may be collected. The viewpoint-specific policy is not necessarily to be prepared for all attributes of the S.F.O.P. Further, multiple viewpoint-specific policies may be prepared for one attribute.

The viewpoint-specific policies include the static viewpoint-specific policy generated from a viewpoint focusing on static attributes of the service application, and the dynamic viewpoint-specific policy generated from a viewpoint focusing on dynamic attributes of the service application. The static attributes of the service application are information about characteristics that do not change depending on the use environment or use conditions of the service application, and include, for example, information indicating the safety of the processing performed by the service application and information indicating the provider of the service application. The dynamic attributes of a service application are information about characteristics that change depending on the use environment and use conditions of the service application, and include, for example, restrictions imposed by the billing contract of the service application provider and information that is arbitrarily set by the vehicle user.

### 4-1. Safety-Related Authorization Policy

A “safety-related authorization policy” will be described as an example of a static viewpoint-specific policy classified as an S attribute.

As a premise, service applications (hereinafter referred to as safety system applications) that perform processes regarding the safety of the vehicle are assigned a safety level (hereinafter referred to as assurance level) that indicates the reliability of the safety of the processes performed by the safety system applications. In addition, an API (hereinafter, safety system API) provided in the safety system application is assigned a safety level (hereinafter, request level) required of a use source service application that uses the API and requests access to the safety system API.

The safety level shall be, for example, the Automotive Safety Integrity Level (hereinafter referred to as ASIL). The ASIL is a risk classification system defined by the ISO 26262 standard for functional safety of vehicles on the road. The ASIL is determined by three parameters: probability of exposure, controllability, and severity, and is expressed on a scale of A to D. The A is the lowest level, and the D is the highest level. No request level is assigned to the non-safety system API, and the fact that no request level is assigned is represented by QM. In other words, the safety level is essentially expressed on a scale of QM, A to D, with QM being the lowest level. The safety level does not necessarily need to use the ASIL, but should be a safety level defined to have multiple levels. Therefore, the safety level also need not to be four levels of A to D, but three levels or less or five levels or more.

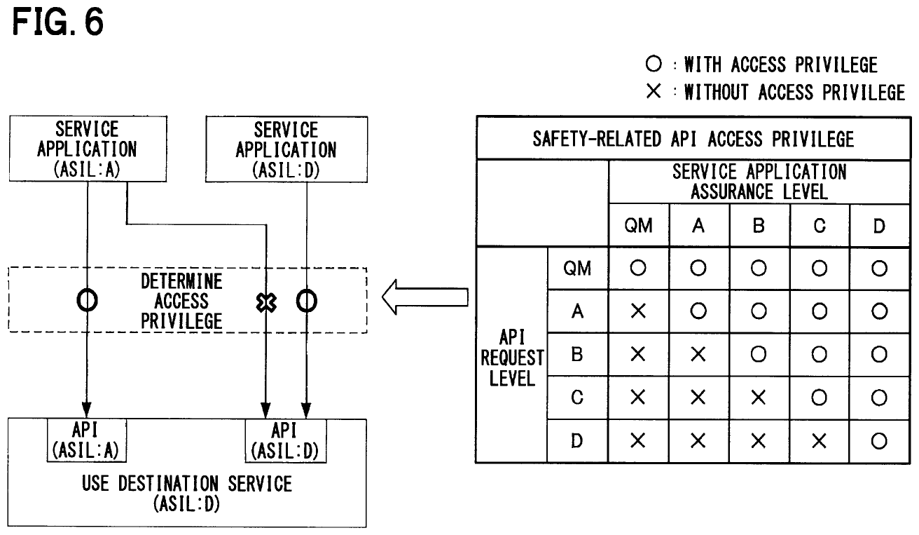

FIG. 6 shows a list expressing the presence or absence of access privilege from a service application to an API, using a matrix showing all combinations of the assurance level of the service application and the request level of the API. In the table, a circle mark indicates that the user has access privilege, and a cross mark indicates that the user does not have the access privilege. Here, the access privilege is present when the provision level is equal to or higher than the request level, and the access privilege is not present when the provision level is lower than the request level. As shown in the left part in FIG. 6, for example, a service application with an assurance level A has access privilege to an API with a request level A, but does not have access privilege to an API with a request level D. A service application with an assurance level D has access privilege to all APIs with the request level of D or more.

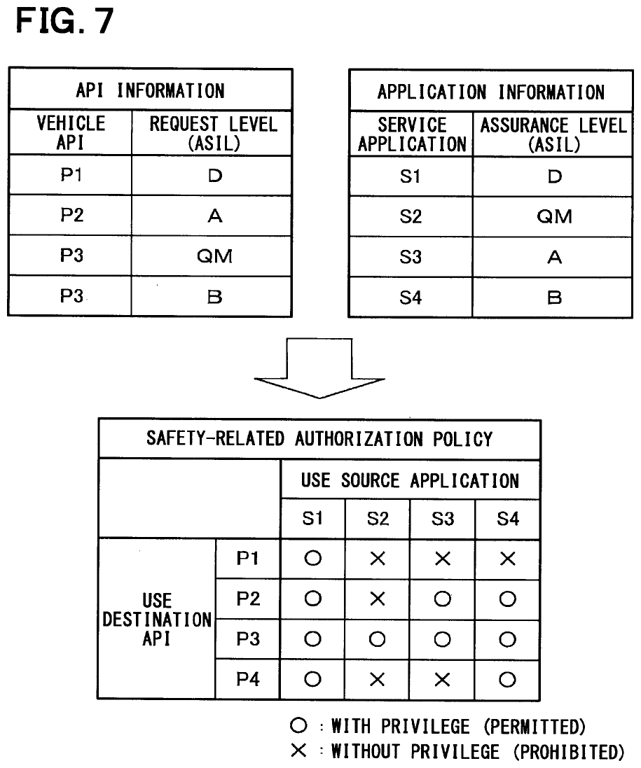

As shown in FIG. 7, the “safety-related authorization policy” is generated by combining the application information, API information, and the list of access privileges shown in FIG. 6.

The application information is information that associates an application ID with an assurance level that is assigned to a service application identified by the application ID. The API information is information that associates an API-ID with a request level assigned to the vehicle API identified by the API-ID.

The contents of the “safety-related authorization policy” are represented by a list that defines whether the use source application identified by an application ID has the access privilege to the use destination API identified by an API-ID.

### 4-2. Company Property-Related Authorization Policy

A “company property-related authorization policy” will be described as an example of the static viewpoint-specific policy classified as an F attribute.

As a premise, a group attribute is assigned to a service application according to its provider. The group attributes are: GA for an OEM application developed in-house; GB for an OEM application developed by another vendor; and GC for a 3rd application developed by a third party.

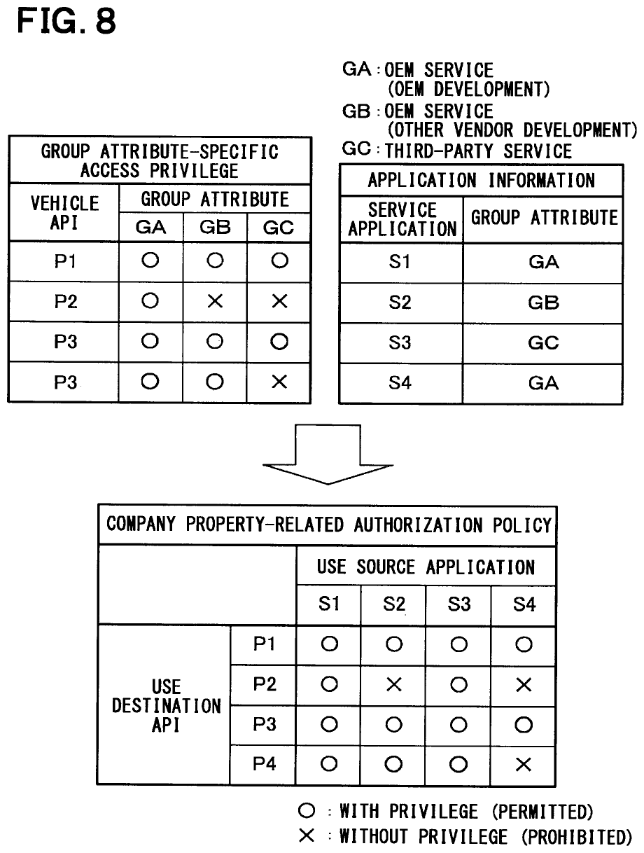

The “company property-related authorization policy” is generated by combining the group attribute-specific access privilege information and the application information, as shown in FIG. 8.

The application information is information that associates the application ID of a service application with a group attribute that is assigned to the service application identified by the application ID.

The group attribute-specific access privilege information is information that indicates whether a service application with a certain group attribute has access privilege to a vehicle API identified by an API-ID, using a matrix that represents all combinations of the API-ID of the vehicle API and group attributes. The reliability of the service applications in terms of group attributes is, for example, GA>GB>GC, and access privilege to each vehicle API is also set based on this reliability.

The contents of the “company property-related authorization policy”, like the “safety-related authorization policy”, are represented by a list that defines whether the use source application identified by an application ID has the access privilege to the use destination API identified by the API-ID.

### 4-3. Personal Property-Related Authorization Policy

A “personal property-related authorization policy” will be described as an example of a dynamic viewpoint-specific policy classified into the F attribute.

The “personal property-related authorization policy” is used to determine whether the access privilege is granted depending on the access status to each vehicle API in accordance with the API billing contract with the service application provider.

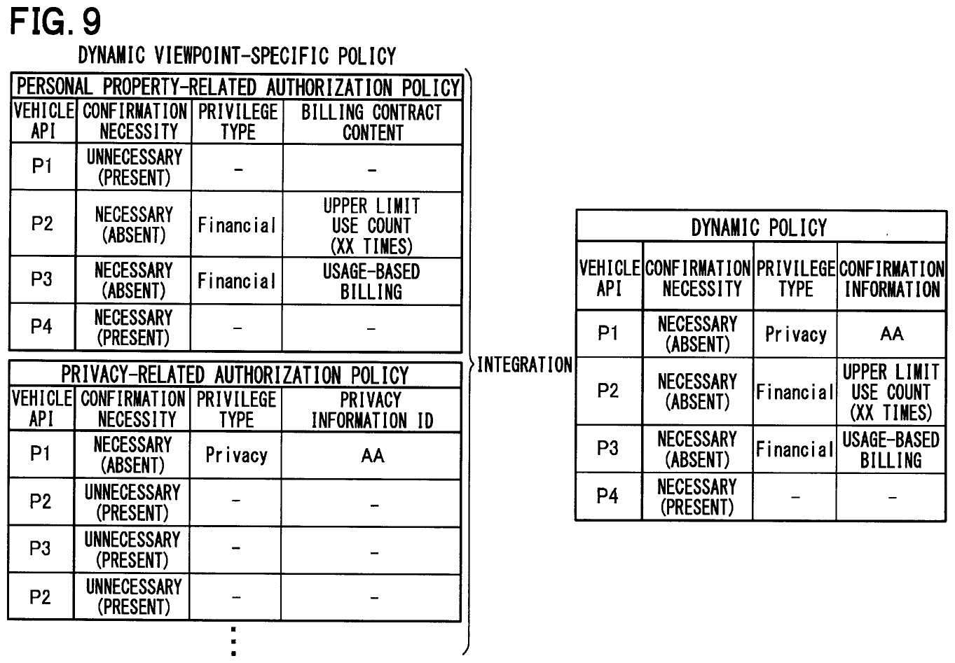

As shown in the upper left part of FIG. 9, the “personal property-related authorization policy” is information that associates an API-ID with confirmation necessity information, privilege type information, and billing contract content information set for the vehicle API identified from the API-ID.

The confirmation necessity information is information that indicates whether personal property-related dynamic privilege confirmation is necessary when determining the access privilege to the vehicle API. Here, it is set that the dynamic authorization confirmation is required when the billing contract exists for access to the vehicle API.

The privilege type information is information indicating which attribute of S.F.O.P the information corresponds to, and in the “personal property-related authorization policy”, it is set to F (i.e., Financial).

The billing contract content information is information that indicates the contents of the billing contract for the vehicle API. For example, the maximum number of times the vehicle API can be used, restrictions on pay-per-use charges, etc. are indicated.

### 4-4. Privacy-Related Authorization Policy

A “privacy-related authorization policy” will be described as an example of the dynamic viewpoint-specific policy classified into the P attribute. The privacy information is information stored in the vehicle that relates to the privacy of the vehicle user.

Whether to permit a service application to access the vehicle user's privacy information, and to what extent, depends on the vehicle user's way of thinking. Therefore, access to privacy information requires the consent of the vehicle user for each content of the privacy information. The consent details regarding privacy information for each vehicle user are shown in the user information 313 shown in FIG. 4.

As shown in the lower left part of FIG. 9, the “privacy-related authorization policy” is information that associates an API-ID with confirmation necessity information, privilege type information, and privacy information ID set for the vehicle API identified by that API-ID.

The confirmation necessity information is information that indicates whether confirmation of dynamic privilege regarding privacy is necessary when determining the access privilege to the vehicle API. Here, it is set that dynamic privilege confirmation is required when the function provided by the vehicle API includes access to privacy information.

The privilege type information is information indicating which attribute of S.F.O.P the information corresponds to, and in the “privacy-related authorization policy”, it is set to P (i.e., Privacy).

The privacy information ID lists IDs assigned to the privacy information that is the target of access by the function of the vehicle API.

### 4-5. Generation of API Authorization Policy

As shown in FIG. 5, the API authorization policy 311 includes a static policy and a dynamic policy.

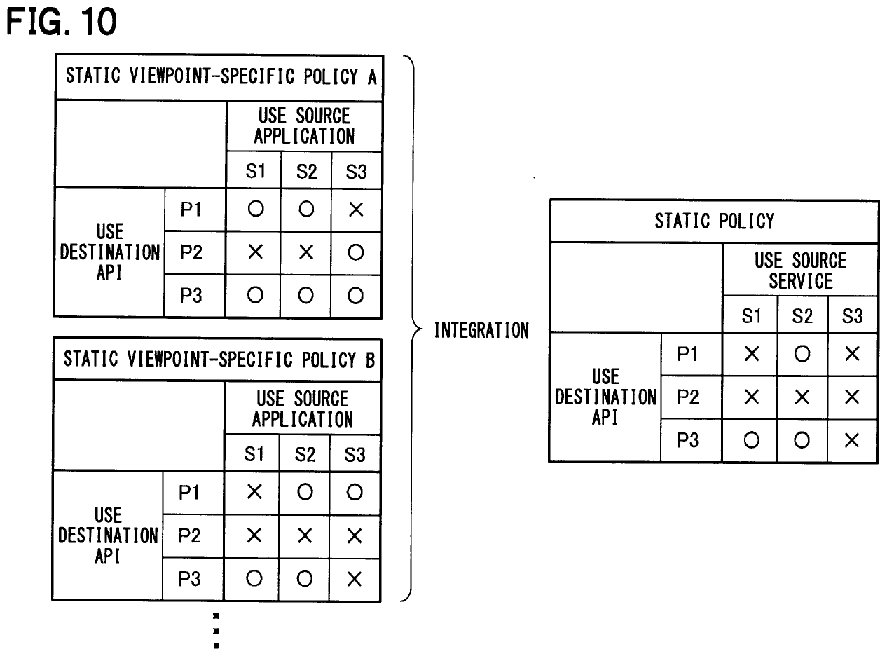

A static policy is generated by integrating multiple static viewpoint-specific policies into one. That is, as shown in FIGS. 7 and 8, each static viewpoint-specific policy is expressed in a matrix format to indicate whether the service application identified by an application ID has access privilege to the vehicle API identified by the API-ID. Therefore, as shown in FIG. 10, each square in the matrix representing the static policy is deemed to have access privilege when it is deemed to have privilege in all of the multiple viewpoint-specific policies that are integration targets, and is deemed to have no access privilege when it is deemed to have no privilege in any one of them.

The dynamic policy is generated by integrating multiple dynamic viewpoint-specific policies into one. That is, as shown in the left part of FIG. 9, in the dynamic viewpoint-specific policy, information is associated with each API-ID. Therefore, as shown on the right part of FIG. 9, the dynamic policy sets confirmation necessity information, privilege type information, and confirmation information for each API-ID based on the multiple dynamic viewpoint-specific policies that are integration targets.

The confirmation necessity information is set to “necessary” when any one of the pieces of confirmation necessity information of the multiple viewpoint-specific policies, which are integration targets, is necessary.

The privilege type information is set to the content set in the privilege type information of the multiple viewpoint-specific policies which are integration targets.

The confirmation information is set to a content according to the setting of the privilege type information. That is, when the privilege type information is set to Financial, the billing contract contents are set as the confirmation information, and when the privilege type information is set to Privacy, the privacy information ID is set as the confirmation information.

Returning to FIG. 5, the cloud server 200 distributes the API authorization policy generated by integrating multiple viewpoint-specific policies in this manner in response to a request from the in-vehicle system 100. The API authorization policy may be distributed in response to a request from the cloud server 200.

In the in-vehicle system 100, the API authorization policy acquired from the cloud server 200 is stored in the information storage 31 of the API gateway 30 and used for the access restriction process.

### 5. Process

### 5-1. Access Restriction Process

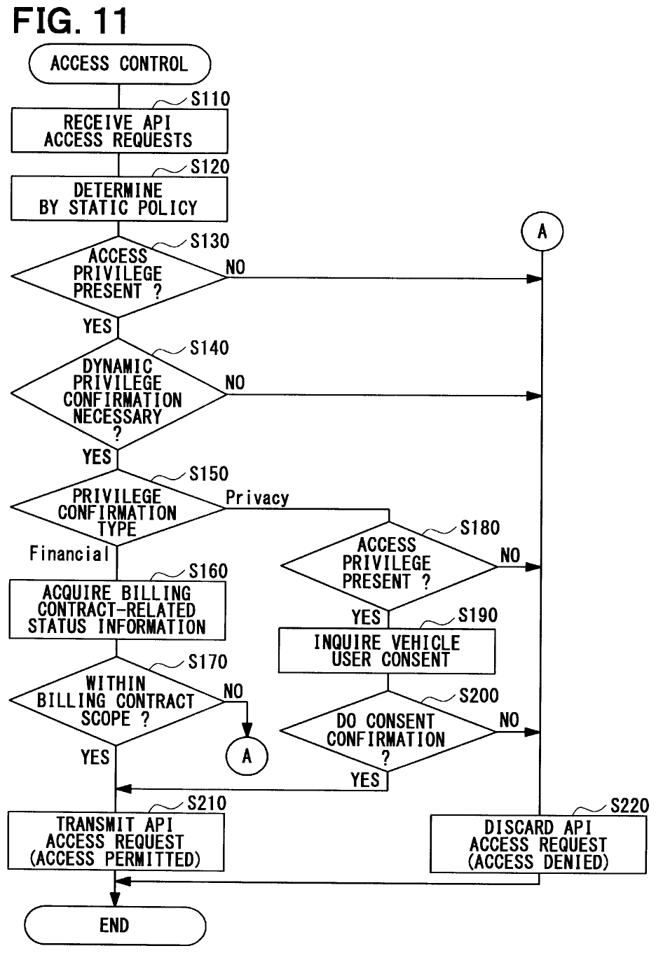

The access control process executed by the access controller 32 will be described using the flowchart in FIG. 11.

In S110, the access controller 32 determines whether it has received the API access request from the service application. When it has received the API access request, the process shifts to S120. When the access controller 32 has not received the API access request, it waits by repeating the same process.

In S120, the access controller 32 determines, based on the information indicated in the API access request, whether the request source application that has issued the API access request has the access privilege, using the static policy among the API authorization policies. Specifically, the access controller 32 first uses the correspondence table 312 to identify the application ID from the process ID indicated in the API access request. Next, the access controller 32 refers to a static policy based on the identified application ID and the API-ID indicated by the API access request, and determines whether the use source application identified from the application ID has the access privilege to the use destination API identified from the AP-ID.

In the next S130, when the access controller 32 determines that the use source application has access privilege to the use destination API, the process shifts to S140, and when it determines that the use source application does not have access privilege, the process shifts to S220.

In S140, the access controller 32 determines whether the dynamic privilege confirmation is required for access to the use destination API by referring to the confirmation necessity information indicated in the dynamic policy. When the access controller 32 determines that dynamic privilege confirmation is necessary, it shifts the process to S150. When the access controller 32 determines that dynamic privilege confirmation is unnecessary, it shifts the process to S220.

In S150, the access controller 32 refers to the privilege confirmation type indicated in the dynamic policy, and when the indicated confirmation type is Financial, the process shifts to S160, and when the indicated confirmation type is Privacy, the process shifts to S180.

In S160, the access controller 32 refers to the billing contract details indicated in the confirmation information of the dynamic policy, and acquire, from the status monitoring unit 33, status information indicating the access status related to the billing contract details.

In the next S170, the access controller 32 determines whether the value indicated in the access status information is within the range of the billing contract contents. When it is within the range of the billing contract contents, the process shifts to S210, and when it is outside the range of the billing contract contents, the process shifts to S220.

In S180, the access controller 32 determines whether the use source application has the access privilege to the privacy information identified by the privacy information ID. This determination is made by referencing the user information 313 using the privacy information ID indicated in the confirmation information of the dynamic policy and the user ID of the vehicle user identified from the use source application. When the access controller 32 determines that there is the access privilege to the privacy information, the process shifts to S190. When the access controller 32 determines that there is no access privilege to the privacy information, the process shifts to S220.

In S190, the access controller 32 inquires of the vehicle user identified by the user ID as to whether the vehicle user agrees to access to the privacy information. The inquiry is made by email or voice call to the contact information registered in association with the user ID.

In the next S200, the access controller 32 determines whether the vehicle user's consent has been acquired as a result of the inquiry in S190. When the consent has been acquired, the process shifts to S210, and when the consent has not been acquired, the process shifts to S220.

In S210, the access controller 32 permits access from the use source application to the use destination API, that is, transmits an API access request to the use destination API, and ends the process.

In S220, the access controller 32 denies access from the use source application to the use destination API, that is, discards the API access request, and ends the process.

### 5-2. Policy Generation Provision Process

The policy generation provision process executed by the controller 201 of the cloud server 200 will be described with reference to a flowchart of FIG. 13.

In S310, the controller 201 acquires the viewpoint-specific policy that is generated individually for each viewpoint. The viewpoint-specific policy may be stored in the storage 202, or may be input from a terminal device or the like connected to the cloud server 200 via a wide area network or the like.

In the next S320, the controller 201 generates an API authorization policy 311 by integrating the multiple viewpoint-specific policies acquired in S310. Of the API authorization policies 311, the static policy is generated by integrating multiple static viewpoint-specific policies as shown in FIG. 10, and the dynamic policy is generated by integrating multiple dynamic viewpoint-specific policies as shown in FIG. 9.

In the next S330, the controller 201 stores the API authorization policy 311 generated in S320 in the storage 202.

In the next S340, when the predetermined provision conditions are satisfied, the controller 201 transmits the API authorization policy 311 stored in the storage 202 to the in-vehicle system 100 to which the policy is to be provided, and ends the process. The provision conditions may include that there is a request from the in-vehicle system 100 and that a new viewpoint-specific policy is stored in the storage 202, and the like.

### 6. Effects

According to the above-described embodiment, the following effects are achieved.

(1) The API authorization policy 311, which is generated by the cloud server 200 (i.e., out-car) and which integrates multiple viewpoint-specific policies, is distributed to the in-vehicle system 100 (i.e., in-car). By using the distributed API authorization policy 311, the in-vehicle system 100 can easily determine whether the use source application has the access privilege to the use destination API without having to make a determination for each viewpoint-specific policy individually. As a result, it is possible to reduce the load on the in-vehicle system 100 required for the determination.

(2) The API authorization policy 311 includes the dynamic policy for determining whether access privilege exists based on information that changes dynamically depending on the situation at any given time and the user's intention. Therefore, it is possible to flexibly deal with access restrictions that change depending on, for example, the contents of a billing contract or the attitude toward private information.

### 7. Correspondence of Terms

The API gateway 30 in the present embodiment corresponds to the coordination controller in the present disclosure. The service applications belonging to the service system function block groups 23 and 24, the control system function block group 25, and the data system function block group 26 in this disclosure correspond to function blocks in the present disclosure. The information storage 31 in the present embodiment corresponds to a policy storage in the present disclosure. The API authorization policy in the present embodiment corresponds to an authorization policy in the present disclosure. The cloud server 200 in the present embodiment corresponds to an authorization policy provision unit and a management server in the present disclosure. The in-vehicle devices 2 to 5 in the present embodiment correspond to an electronic control unit in the present disclosure. The storage 202 in the present embodiment corresponds to an authorization policy storage in the present disclosure. The processes S310 to S330 executed by the controller 201 in the present embodiment correspond to an authorization policy generating unit in the present disclosure. The process S340 executed by the controller 201 in the present embodiment corresponds to an authorization policy provision unit in the present disclosure.

### 8. Other Embodiments

Although the embodiment of the present disclosure has been described above, the present disclosure is not limited to the embodiment described above, and various modifications can be made to implement the present disclosure.

(a) In the above embodiment, no example is given for the O attribute, but it is possible to use an attribute-based policy generated with the same idea as in the case of the S attribute. For example, in controlling an air conditioner, a policy may be set so that AUTO setting is not changed to an unpleasant setting. While the S attribute targets matters that are life-threatening, the O attribute also targets comfort and convenience.

(b) In the above embodiment, the ECU 2 includes both the real-time processing unit 10 and the application processing unit 20, but it may include only one of them.

(c) In the above embodiment, although the ECU 2 is equipped with the service system function block groups 23, 24, a control system function block group 25, and a data system function block group 26, other in-vehicle devices 3 to 5 may be equipped with at least a portion of the function block groups 23 to 26. In addition, the function block groups 23 to 26 may be centrally arranged in any one of the in-vehicle devices 2 to 5, or may be distributed in multiple in-vehicle devices 2 to 5.

(d) The in-vehicle devices 2 to 5 and the like and the methods according to the present disclosure may be achieved by a dedicated computer provided by constituting a processor and a memory programmed to execute one or more functions embodied by a computer program. Alternatively, the in-vehicle devices and the like and the methods according to the present disclosure may be achieved by a dedicated computer provided by constituting a processor with one or more dedicated hardware logic circuits. Alternatively, the in-vehicle devices and the like and the methods described in the present disclosure may be achieved by one or more dedicated computers configured by combinations of processors and memories programmed to perform one or more functions and processors configured by one or more hardware logic circuits. The computer program may be stored in a computer-readable non-transitory tangible storage medium as instructions to be executed by a computer. The technique for implementing the functions of each unit included in the in-vehicle devices and the like does not necessarily need to include software, and all the functions may be implemented using one or a plurality of hardware circuits.

(e) A plurality of functions of one element in the above embodiment may be implemented by a plurality of elements, or one function of one element may be implemented by a plurality of elements. In addition, multiple functions of multiple components may be realized by one component, or a single function realized by multiple components may be realized by one component. Part of the configuration of the above embodiment may be omitted. At least a part of the configuration in one embodiment may be added to or substituted for the configuration of another embodiment.

(f) In addition to the above-described mobility service provision system 1, the in-vehicle system 100, and the cloud server 200 as the authorization policy provision unit and the management server, the present disclosure can also be implemented in various forms, such as a program for causing a computer to function as the in-vehicle system 100 and the authorization policy provision unit, a non-transitory tangible storage medium such as a semiconductor memory in which this program is stored, and an access control method.

What is claimed is:

1. A mobility service provision system comprising:
an in-vehicle system that includes a plurality of electronic control units that are mounted in a vehicle and connected to an in-vehicle network;
an authorization policy provision unit provided outside the vehicle,
wherein
the in-vehicle system includes:
a plurality of function blocks, each of which is mounted in one of the plurality of electronic control units and configured to execute a predetermined process; and
a coordination controller configured to implement coordination between the plurality of function blocks,
the coordination controller includes:
a policy storage configured to acquire and store an authorization policy that defines an access privilege between the plurality of function blocks from the authorization policy provision unit; and
an access controller configured to
when receiving an access request from a use source block that is one of the plurality of function blocks to a use destination block that is another of the plurality of function blocks, determine whether the access privilege of the use source block to the use destination block is present based on the authorization policy stored in the policy storage, and transmit the access request to the use destination block when determining that the access privilege is present, and
the authorization policy provision unit is configured to provide, to the in-vehicle system, as the authorization policy, a static viewpoint policy generated by integrating a plurality of viewpoint-specific policies based on the plurality of viewpoint-specific policies that define the access privilege for each of a plurality of viewpoints focusing on a static attribute of the plurality of function blocks.

2. The mobility service provision system according to claim 1, wherein
one of the plurality of viewpoint-specific policies has, as a viewpoint, safety of a function provided by the plurality of function blocks.

3. The mobility service provision system according to claim 1, wherein
one of the plurality of viewpoint-specific policies has a viewpoint of reliability of a provider of the plurality of function blocks.

4. The mobility service provision system according to claim 1, wherein
the authorization policy includes, in addition to the static viewpoint policy, at least one dynamic viewpoint policy that defines the access privilege for each of at least one viewpoint focusing on a dynamic attribute of the plurality of function blocks.

5. The mobility service provision system according to claim 4, wherein
one of the at least one dynamic viewpoint policy has, as the viewpoint, presence or absence of consent of a vehicle user.

6. The mobility service provision system according to claim 4, wherein
one of the at least one dynamic viewpoint policy has, as the viewpoint, an access status between the plurality of function blocks.

7. The mobility service provision system according to claim 1, wherein
the authorization policy is generated to have, as the viewpoint, at least one of safety, finance, operation, or privacy, and
the safety, the finance, the operation, and the privacy are classified as a security protection asset.

8. An in-vehicle system comprising:
a plurality of function blocks, each of which is mounted in one of a plurality of electronic control units connected to an in-vehicle network and configured to execute a predetermined process; and
a coordination controller configured to implement coordination between the plurality of function blocks,
wherein
the coordination controller includes:
a policy storage configured to store an authorization policy that defines an access privilege between the plurality of function blocks;
an access controller configured to
when receiving an access request from a use source block that is one of the plurality of function blocks to a use destination block that is another of the plurality of function blocks, determine whether the access privilege of the use source block to the use destination block is present based on the authorization policy stored in the policy storage, and
transmit the access request to the use destination block when determined that the access privilege is present, and
the authorization policy includes a static viewpoint policy generated by integrating a plurality of viewpoint-specific policies based on the plurality of viewpoint-specific policies that define the access privilege for each of a plurality of viewpoints focusing on a static attribute of the plurality of function blocks.

9. A management server communicably connected to a vehicle including an in-vehicle system including a plurality of electronic control units connected to an in-vehicle network, the management server comprising:
an authorization policy storage that is mounted in any one of the plurality of electronic control units and configured to store an authorization policy referenced for controlling an access privilege from a use source block that is one of a plurality of function blocks configured to execute a predetermined process to a use destination block that is another one of the plurality of function blocks;
an authorization policy generation unit configured to
generate a static viewpoint policy by integrating a plurality of viewpoint-specific policies based on the plurality of viewpoint-specific policies that define the access privilege for each of a plurality of viewpoints focusing on a static attribute of the plurality of function blocks, and
cause the authorization policy storage to store the static viewpoint policy as the authorization policy; and
an authorization policy provision unit configured to provide the authorization policy stored in the authorization policy storage to the vehicle.

10. The management server according to claim 9, wherein
the authorization policy generation unit is configured to
generate a dynamic viewpoint policy by integrating a plurality of viewpoint-specific policies based on the plurality of viewpoint-specific policies that define the access privilege for each of a plurality of viewpoints focusing on a dynamic attribute of the plurality of function blocks, and
cause the authorization policy storage to store the dynamic viewpoint policy as the authorization policy.

11. An access control method for controlling an access between a plurality of function blocks by at least one of a plurality of electronic control units using an authorization policy that defines an access privilege between the plurality of function blocks, each which is mounted on any one of the plurality of electronic control units and configured to execute a predetermined process, the at least one of a plurality of electronic control units being connected to an in-vehicle network, the access control method comprising:
using, as the authorization policy, a static viewpoint policy generated by integrating a plurality of viewpoint-specific policies based on the plurality of viewpoint-specific policies that define the access privilege for each of a plurality of viewpoints focusing on a static attribute of the plurality of function blocks;
when receiving an access request from a use source block that is one of the plurality of function blocks to a use destination block that is another of the plurality of function blocks, determining whether the access privilege of the use source block to the use destination block is present according to the authorization policy; and
transmitting the access request to the use destination block when determined that the access privilege is present.

12. A non-transitory computer-readable storage medium storing a program for controlling an access between a plurality of function blocks by using an authorization policy that defines an access privilege between the plurality of function blocks, each which is mounted on any one of a plurality of electronic control units and configured to execute a predetermined process, at least one of the plurality of electronic control units being connected to an in-vehicle network, the program being configured to:
use, as the authorization policy, a static viewpoint policy generated by integrating a plurality of viewpoint-specific policies based on the plurality of viewpoint-specific policies that define the access privilege for each of a plurality of viewpoints focusing on a static attribute of the plurality of function blocks; and
cause a computer to implement a function of:
when receiving an access request from a use source block that is one of the plurality of function blocks to a use destination block that is another of the plurality of function blocks, determining whether the access privilege of the use source block to the use destination block is present according to the authorization policy; and
transmitting the access request to the use destination block when determined that the access privilege is present.
